(19) United States
(12) Patent Application Publication
(10) Pub. No.: US 2026/0288889 A1
(43) Pub. Date: Sep. 24, 2026

(54) STORAGE MEDIUM, INFORMATION PROCESSING APPARATUS, AND CONTROL METHOD FOR WEB SITE SEARCH

(71) Applicant: CANON KABUSHIKI KAISHA, Tokyo (JP)

(72) Inventor: KENICHI HIROSE, Kanagawa (JP)

(21) Appl. No.: 19/571,307

(22) Filed: Mar. 18, 2026

(30) Foreign Application Priority Data
Mar. 24, 2025 (JP) 2025-048791

(51) Int. Cl. G06F 16/9538; G06F 16/903

(52) U.S. Cl. CPC G06F 16/9538; G06F 16/90344

(57) ABSTRACT

A browser program creates a first search query by adding a product name corresponding to a product-specific page of a website to a search query input from the product-specific page being viewed on a browser, and acquires a search result obtained by searching the website using the first search query. In a case where a character string of the first search query is not included in the search result, the browser program executes processing for performing a search using a search query obtained by excluding the product name from the first search query.

### BACKGROUND

### Field of the Technology

The present disclosure relates to a storage medium, an information processing apparatus, and a control method therefor.

### Description of the Related Art

In a website that has separate pages for each product, such as a website that provides manuals for a plurality of products, there are cases where the website includes pages that describe different information for each product and pages that describe the same information regardless of the product. In such a case, the website may include, for example, product-specific pages that describe different information for each product and information including a product name, and product-common pages that describe only the same information regardless of the product.

In such a website, there is a technique that, when a user performs a search in the website from a product-specific page, a product name keyword is automatically added to a search query for the search to limit the search range to only the product-specific pages. Hereinafter, a function corresponding to this technique will be referred to as a "product-name automatic-addition search function."

Japanese Patent Laid-Open No. 2002-92033 describes a technique in which a keyword is extracted from a search query input by a user, an objective keyword associated with the extracted keyword is acquired by table lookup, and a search is executed by including the extracted keyword and the acquired objective keyword in the search query.

In a website including product-specific pages containing product information and product-common pages not containing the product information, when a search is performed with a search query including a product name keyword, only the product-specific pages containing product information are hit as pages that match the search query.

In the case of a website with the above-described product-name automatic-addition search function, when a user performs a search while viewing a product-specific page, the product name keyword is automatically added to the search query for the search, which unintentionally limits the search range to the product-specific pages only. Accordingly, when the page the user wants to find in a search is a product-common page, the target page may not appear in a search result.

### SUMMARY

The present disclosure is directed to providing a mechanism that increases the likelihood of a user finding a target page even when the target page is a product-common page that does not include a product name.

According to an aspect of the present disclosure, a non-transitory computer-readable storage medium stores a program for displaying, on a web browser, a search result of content in a website obtained from a search service server in response to a search instruction for the website including a product-specific page and a product-common page, wherein the program causes a computer to function as: a first creation unit configured to create a first search query by automatically adding, by the program, a product name corresponding to the product-specific page to a search query input from the product-specific page being viewed in the web browser, a first acquisition unit configured to communicate with the search service server and acquire a first search result obtained by searching the website using the first search query, a first determination unit configured to determine whether a character string of the first search query is included in the acquired first search result, and a first execution unit configured to, in a case where the character string of the first search query is not included in the first search result, execute processing for performing a search using a search query obtained by excluding the product name automatically added by the program in creating the first search query from the first search query.

Features of the present disclosure will become apparent from the following description of embodiments with reference to the attached drawings. The following description of embodiments is described by way of example.

### BRIEF DESCRIPTION OF THE DRAWINGS

FIG. 1 is a diagram illustrating an example of a configuration of a system.

FIG. 2 is a diagram illustrating an example of a website that provides product manuals.

FIG. 3 is a diagram illustrating an example of search ranges on the website.

FIGS. 4A to 4F are diagrams illustrating examples of browser screens.

FIG. 5 is a sequence diagram illustrating an example of search processing according to a first embodiment.

FIG. 6 is a flowchart illustrating an example of search query inclusion check processing.

FIG. 7 is a diagram illustrating an example of search result information.

FIG. 8 is a sequence diagram illustrating an example of search processing according to a second embodiment.

FIG. 9 is a sequence diagram illustrating an example of search processing according to a third embodiment.

FIG. 10 is a diagram illustrating an example of a browser screen according to the third embodiment.

### DESCRIPTION OF THE EMBODIMENTS

Hereinafter, embodiments of the present disclosure will be described in detail with reference to the accompanying drawings. Note that the following embodiments do not limit the present disclosure as set forth in the claims, and not all combinations of features described in the present embodiments are essential to the solutions of the present disclosure.

### First Embodiment

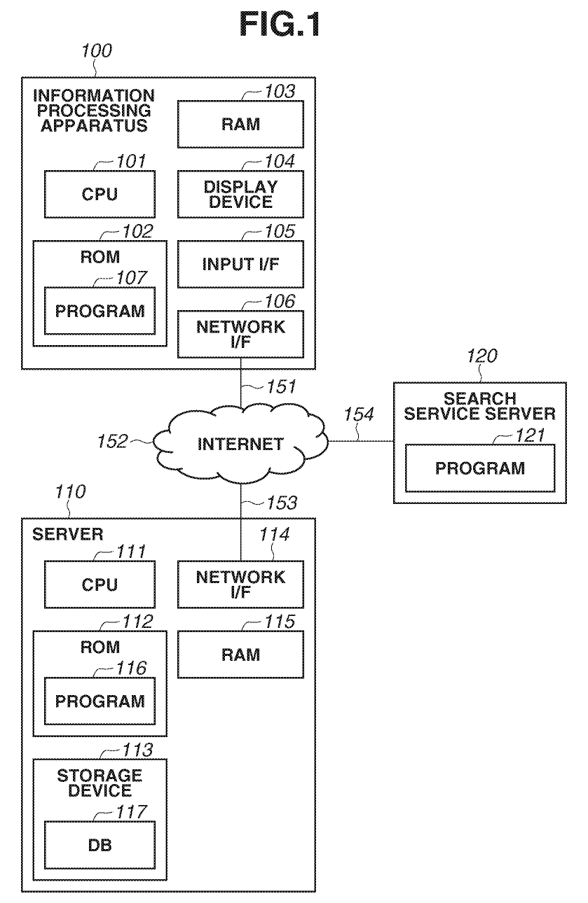

FIG. 1 is a diagram illustrating an example of a configuration of a system according to a first embodiment, a second embodiment and a third embodiment.

As illustrated in FIG. 1, the system of the present embodiment includes an information processing apparatus 100, a server 110, and a search service server 120. Configurations of the information processing apparatus 100, the server 110, and the search service server 120 will be described. Hereinafter, an interface will be denoted as "I/F."

The information processing apparatus 100 may be a personal computer (PC), a tablet terminal, a smartphone, or the like, and a web browser (hereinafter referred to as a "browser") is installed therein. The information processing apparatus 100 includes a central processing unit (CPU) 101, a read only memory (ROM) 102, a random access memory (RAM) 103, a display device 104, an input I/F 105, and a network I/F 106. The ROM 102 stores computer-readable programs 107 such as an operating system (OS) and a browser. The information processing apparatus 100 may also include other storage devices such as a hard disk drive (HDD) or a solid state drive (SSD). The CPU 101 reads programs stored in the ROM 102 and the like into the RAM 103 and executes the programs to perform various kinds of control.

The information processing apparatus 100 can be connected to the Internet 152 via a network connection 151 using a cable for Ethernet (registered trademark) or the like or via Wi-Fi.

The server 110 is a web server that provides a website. The server 110 includes a CPU 111, a ROM 112, a storage device 113, a network I/F 114, and a RAM 115. The ROM 112 or the storage device 113 stores an OS, various programs 116 for performing search processing and search result display processing, and contents such as web contents. In the present embodiment, the server 110 provides a website provided by a printer vendor. The storage device 113 includes a database (DB) 117 for a product name list and the like, and manages product names and the like. A product name specifically refers to a model name or a model number, for example.

More specifically, in the present embodiment, the product name refers to a model name or a model number of a printer provided by the printer vendor described above. Further, the model name or the model number, in other words, corresponds to a machine name or a machine number. The storage device 113 is, for example, an HDD, an SSD, or an embedded multimedia card (eMMC).

The server 110 can be connected to the Internet 152 via a network connection 153. The information processing apparatus 100 and the server 110 can communicate with each other via the Internet 152.

The server 110 may be implemented by a single computer or by a plurality of computers. For example, the server 110 may be implemented using a cloud computing technology.

The search service server 120 is a server that provides a search service. The hardware configuration of the search service server 120 is similar to that of, for example, the server 110.

The search service server 120 includes a program 121 that is a search engine. Examples of the search engine include Google (registered trademark) Web Search and Microsoft Bing (registered trademark). The search service server 120 can be connected to the Internet 152 via a network connection 154.

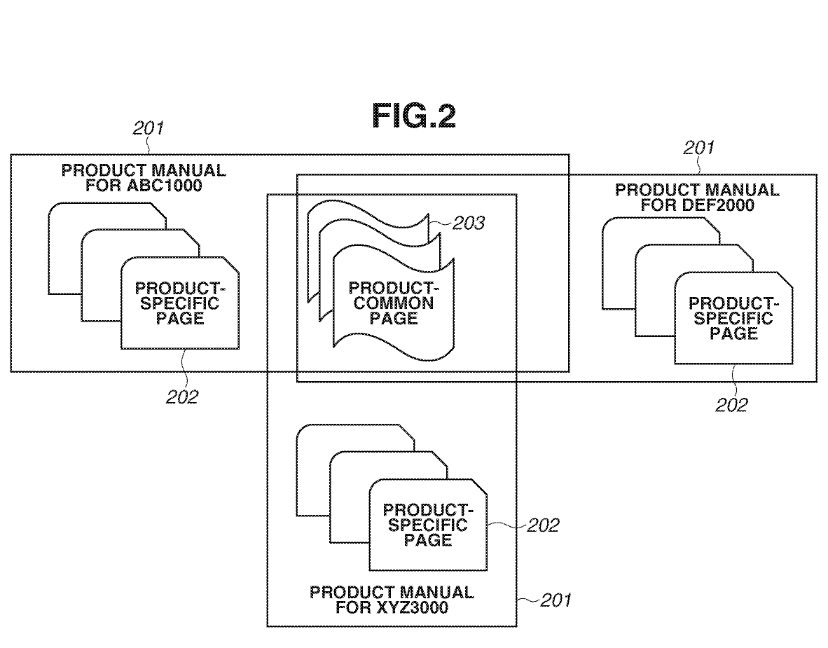

FIG. 2 is a diagram illustrating an example of a website that provides product manuals.

The website illustrated in FIG. 2 includes a plurality of product manuals 201 for individual products.

Each product manual 201 includes product-specific pages 202 and product-common pages 203.

The product-common pages 203 are included in a configuration of the plurality of product manuals 201. For example, the product-common pages 203 included in a configuration of product manuals for models ABC1000, DEF2000, and XYZ3000 are the same pages. In the present embodiment, products of the above-described models are assumed to be printers.

The product-specific pages 202 and the product-common pages 203 are, for example, HyperText Markup Language (HTML) files. The HTML files of the product-specific pages 202 include a product name character string in any one of a page title, a page body, or a Uniform Resource Locator (URL). The HTML files of the product-common pages 203 may not include the product name character string in the page title, the page body, or the URL.

The website illustrated in FIG. 2 has an on-site search function that uses a search service. This function includes a function that automatically includes the product name in a search query when a search is performed from a product-specific page. For example, when a user is viewing the product manual for an apparatus with the model name of XYZ3000 and inputs a search query "scan app launch" to instruct the website to perform a search, the website automatically adds the product name character string to the search query, such as "XYZ3000 scan app launch," and performs a search. As described above, a search in which the website automatically adds the product name character string to a search query is referred to as a product-name automatic-addition search. In other words, automatically adding the product name character string to the search query means that the website automatically adds the product name character string to a search query and performs a search even though the user has not input the product name character string as the search query.

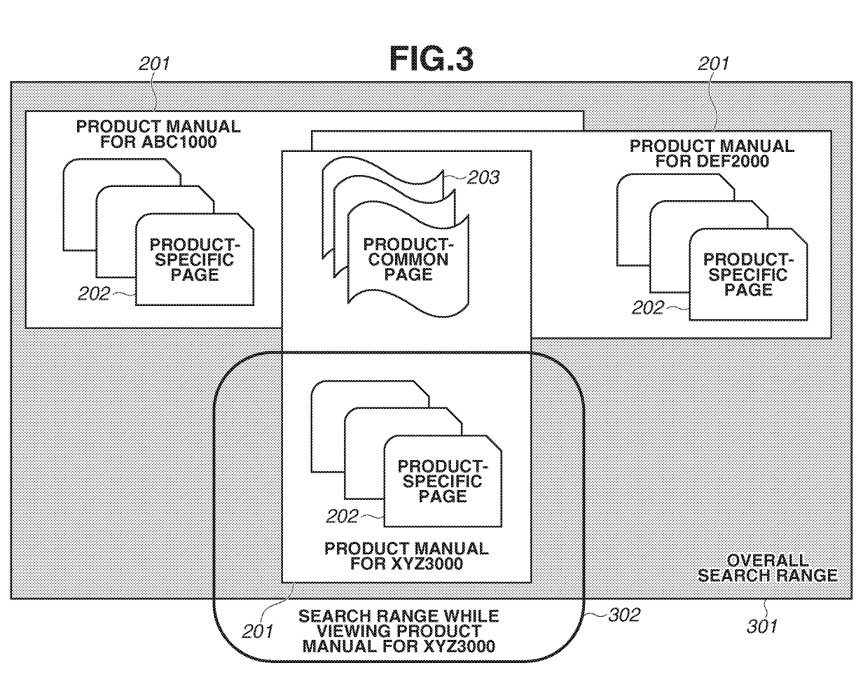

FIG. 3 is a diagram illustrating an example of ranges to be searched when an on-site search is performed on the website as described with reference to FIG. 2.

In a case where a search is performed without including a product name keyword in the search query, pages across the entire website can be returned as search hits (which constitute an actual search range) as indicated by an overall search range 301. Specifically, the range for the overall search is such that the product-specific pages 202 for each product and the product-common pages 203 may be returned as search results. In the present embodiment, the overall search range 301 refers to the entirety of a plurality of web pages as manuals provided by the printer vendor that provides printers of models such as XYZ3000. More specifically, in the present embodiment, the product-name automatic-addition search and a product-name exclusion search described below are performed within a range of the entirety of the plurality of web pages. In other words, a search range for the product-name automatic-addition search and a search range for the product-name exclusion search are the same. Furthermore, the entirety of the plurality of web pages is stored and managed by the server 110.

On the other hand, in a case where a search is performed including the product name keyword in the search query, only the product-specific pages 202 in the product manual 201 may be returned as a search result (which constitute the actual search range), as indicated by a product-specific search range 302. For example, when a search is performed with a keyword "XYZ3000" included in the search query, only the product-specific pages 202 for XYZ3000 may be returned as a search result, and the product-specific pages 202 for ABC1000, the product-specific pages 202 for DEF2000, and the product-common pages 203 are not returned as a search result.

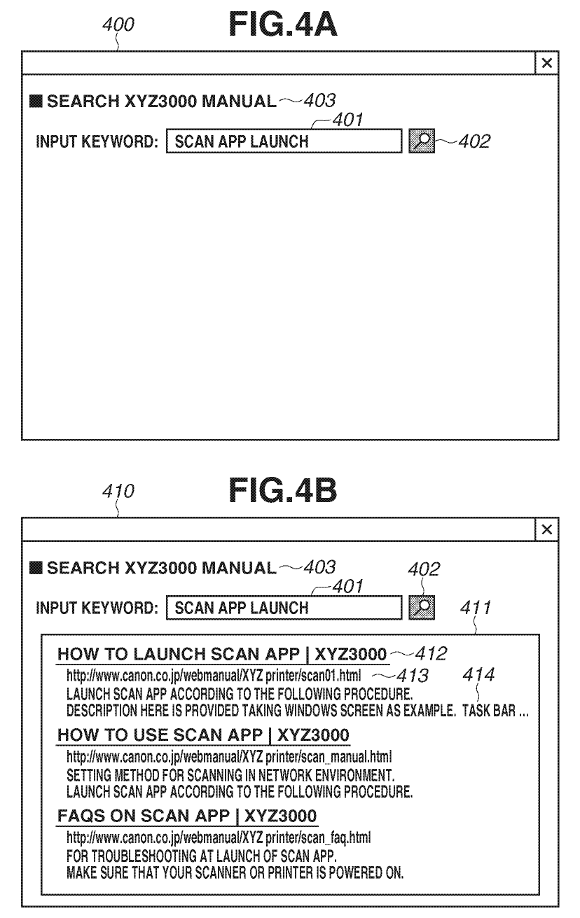

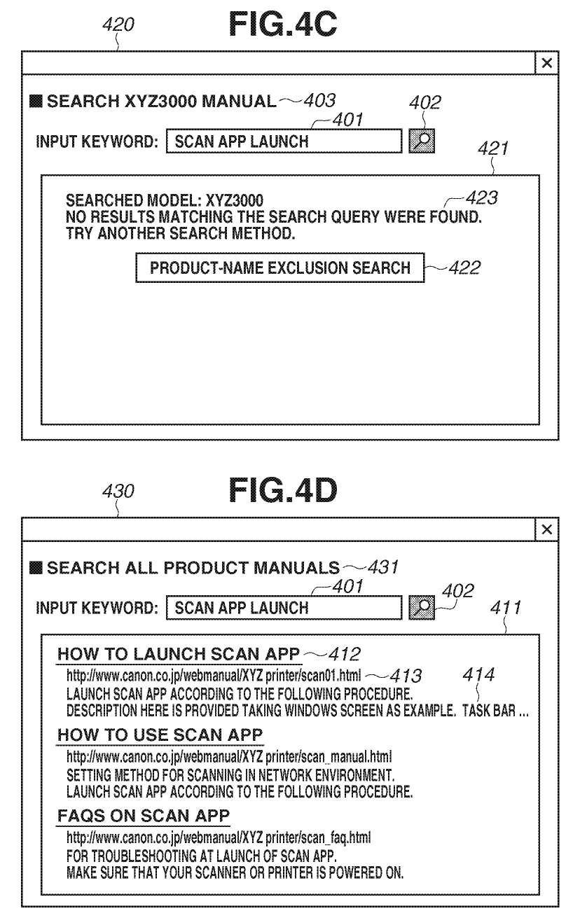

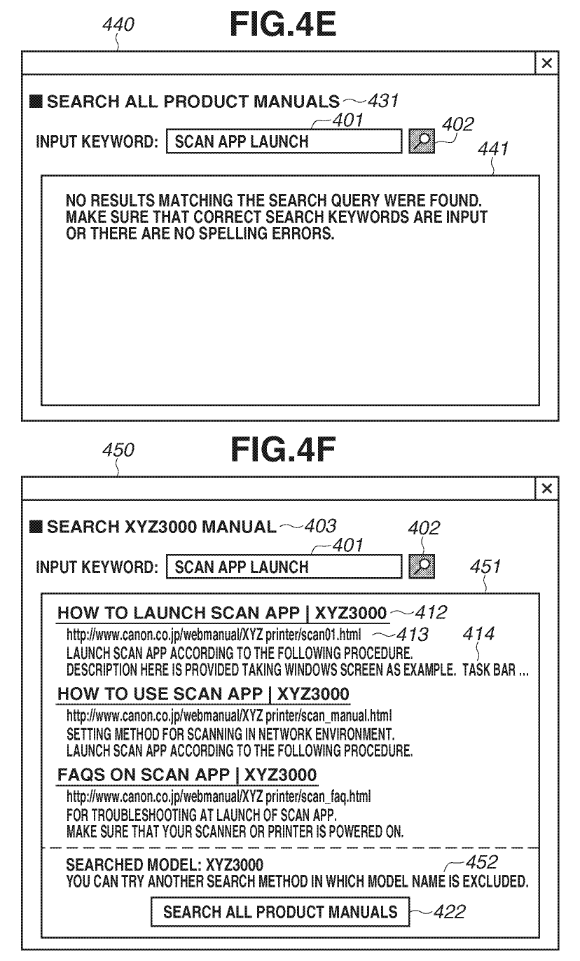

In the first embodiment, a processing flow is described for an on-site search of the website performed by a user, in which a search is performed using a search query that includes a product name keyword, and when no page matching the search query is found, guidance is provided for a search method in which the product name keyword is preferentially excluded from the search query. Hereinafter, a detailed description will be provided with reference to FIGS. 4A to 4F, 5, 6, and 7.

FIGS. 4A to 4F are diagrams illustrating examples of browser screens displayed on the display device 104 of the information processing apparatus 100.

When a user accesses the website illustrated in FIGS. 2 and 3 from the information processing apparatus 100 via the Internet 152, screens as illustrated in FIGS. 4A to 4F are displayed on the browser executed on the information processing apparatus 100.

FIG. 4A is an example of a search start screen 400 of the website displayed on the browser of the information processing apparatus 100.

The search start screen 400 includes a search query input field 401, a search execution button 402, and a product name title 403 that clearly indicates a product name to be searched for.

On the search start screen 400, when a user inputs characters as a search query into the search query input field 401 and then presses the search execution button 402, search processing is executed.

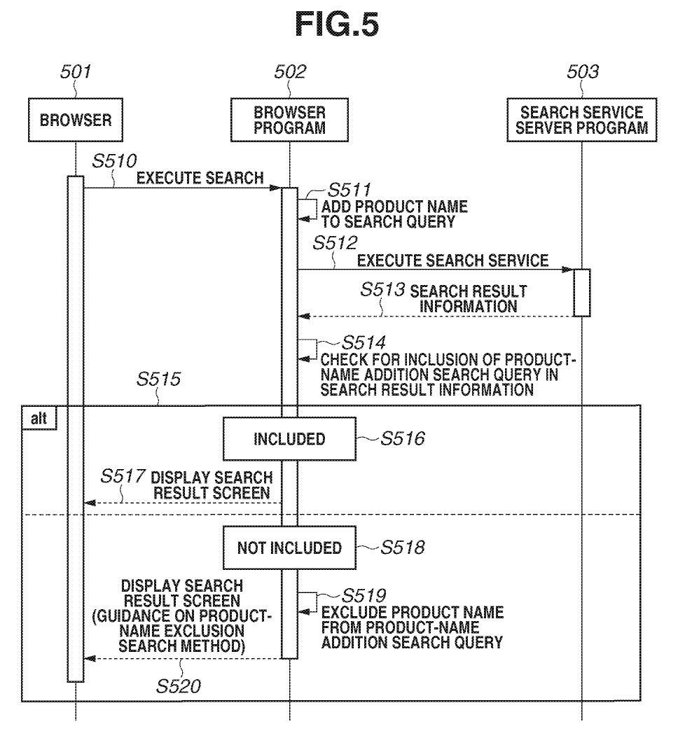

FIG. 5 is a search processing sequence diagram illustrating an example of a processing flow when search processing is executed on the search start screen 400 displayed on a browser 501 in the first embodiment.

The browser 501 is a program 107 that is stored in the ROM 102 or the like of the information processing apparatus 100 and that is read into the RAM 103 and executed by the CPU 101. More specifically, the processing performed by the browser 501 is actually performed by the CPU 101 executing the browser 501.

A browser program 502 is a program that is downloaded from the contents of the server 110 to the RAM 103 of the information processing apparatus 100 and that runs on the browser 501. The browser program 502 is a program such as JavaScript (registered trademark) and performs processing such as displaying a website on the browser 501. More specifically, the processing performed by the browser program 502 is actually performed by the CPU 101 executing the browser program 502 on the browser 501.

A search service server program 503 is the search engine program 121 that runs on the search service server 120. More specifically, the processing performed by the search service server program 503 is actually performed by a CPU of the search service server 120 executing the search service server program 503.

Hereinafter, a flow of search processing will be described.

When the user inputs a search query into the search query input field 401 on the search start screen 400 displayed on the browser 501 by the browser program 502 and presses the search execution button 402, the browser 501 that has detected this operation executes step S510.

In step S510, the browser 501 issues, to the browser program 502, an instruction to execute a search using the search query input to the search query input field 401.

Upon receipt of this instruction to execute a search, the browser program 502 executes step S511.

In step S511, the browser program 502 creates a search query in which a product name keyword of the product in the manual being viewed is added to the search query. For example, if the user is viewing a product-specific page for XYZ3000 and the search query is "scan app launch," the search query created in step S511 will be "XYZ3000 scan app launch."

Next, in step S512, the browser program 502 issues, to the search service server program 503, an instruction to execute a search service using the search query created in step S511.

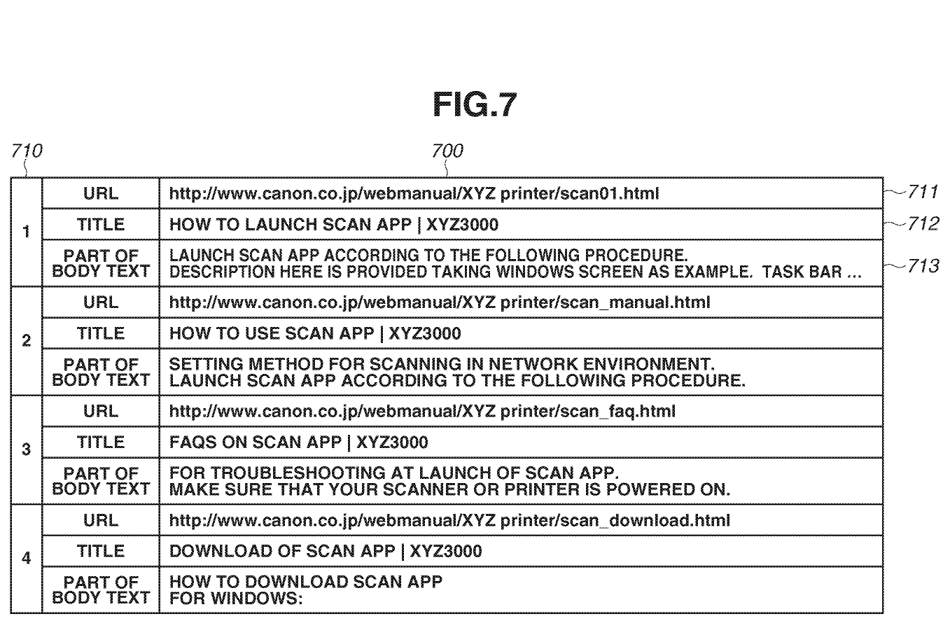

Then, in step S513, the browser program 502 acquires search result information returned by the search service server program 503. The search result information will be described with reference to FIG. 7.

FIG. 7 is a diagram illustrating an example of the search result information.

As illustrated in FIG. 7, search result information 700 includes one or more search result items 710, which indicate information on web pages hit in a search.

A search result item 710 includes information such as a web page URL 711, a web page title 712, and a part 713 of body text of a web page.

Next, in step S514, the browser program 502 checks whether the search result information acquired in step S513 includes keywords of the search query.

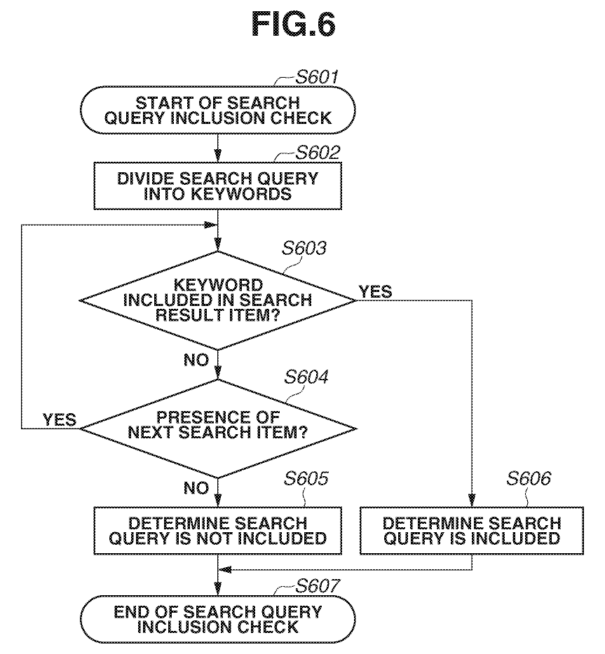

Processing in step S514 will be described in detail with reference to FIG. 6.

FIG. 6 is a flowchart illustrating an example of processing performed by the browser program 502 from the start to the end of a search query inclusion check (step S514) of the search result information.

In step S601, the search query inclusion check is started. In step S602, the browser program 502 divides the search query for the search executed in step S512 of FIG. 5 into keywords. For example, when the search query is "XYZ3000 scan app launch," the search query is divided into four keywords: "XYZ3000," "scan," "app," and "launch."

Next, in step S603, the browser program 502 acquires an unprocessed search result item 710 from the search result information 700 acquired in step S513 of FIG. 5, and determines whether the keywords obtained by division are included in the search result item 710. For example, if the first keyword among the keywords obtained by division is the character string "XYZ3000," the browser program 502 determines whether the keyword "XYZ3000" obtained by division is included in any of the URL 711, title 712, or the part 713 of the body text of the search result item 710.

If the browser program 502 determines that at least one of the keywords obtained by division is included in the search result item 710 (YES in step S603), the processing proceeds to step S606.

In step S606, the browser program 502 determines that the search query is "included" in the search result information, and in step S607, the processing of this flowchart is ended.

On the other hand, if the browser program 502 determines that none of the keywords obtained by division are included in the search result item 710 (NO in step S603), the processing proceeds to step S604.

In step S604, the browser program 502 determines whether there is a next search item, i.e., whether there is an unprocessed search result item 710 in the search result information 700.

If the browser program 502 determines that there is a next search item (YES in step S604), the browser program 502 repeats the processing in step S603 and the subsequent steps.

On the other hand, if the browser program 502 determines that there is no next search item (NO in step S604), the processing proceeds to step S605.

In step S605, the browser program 502 determines that the search query is "not included" in the search result information, and in step S607, the processing of this flowchart is ended.

Hereinafter, the description will again be provided with reference to FIG. 5.

Upon completion of step S514 (search query inclusion check of the search result information), the processing proceeds to step S515.

In step S515, when the browser program 502 has determined in the processing of step S514 described above that the product name addition search query is "included" in the search result information, i.e., in the case of step S516, in step S517, the browser program 502 displays a product-specific search result screen 410 as illustrated in FIG. 4B on the browser 501.

FIG. 4B is an example of the product-specific search result screen 410 displayed on the browser of the information processing apparatus 100. Note that the same elements as those in FIG. 4A are denoted by the same reference numerals.

The product-specific search result screen 410 includes a search result area 411.

The browser program 502 displays the search result information (an example is illustrated in FIG. 7) returned from the search service server program 503 in the search result area 411 as a search result list.

The search result list includes, for example, a page title 412, a page URL 413, and a part 414 of body text of a page.

On the other hand, in step S515, when the browser program 502 has determined in the processing of the above-described step S514 that the product name addition search query is "not included" in the search result information, i.e., in the case of step S518, in step S519, the browser program 502 creates a product-name exclusion search query by excluding the product name from the product-name addition search query. The product name to be excluded here is the character string automatically added to the search query in the product-name automatic-addition search. By the product name being excluded, the created product-name exclusion search query includes only the characters input by the user to the search query on the search start screen 400.

Further, in step S520, the browser program 502 displays, on the browser 501, a product-name exclusion search guidance screen 420 as illustrated in FIG. 4C. The product-name exclusion search guidance screen 420 will be described.

FIG. 4C is an example of the product-name exclusion search guidance screen 420 displayed on the browser of the information processing apparatus 100. Note that the same elements as those in FIG. 4A are denoted by the same reference numerals.

The product-name exclusion search guidance screen 420 includes an alternative search method guidance area 421.

The alternative search method guidance area 421 includes a message 423 (including text indicating the searched model, that no results matching the search query were found, and prompting the user to try another method), and a product-name exclusion search button 422.

When the user presses the product-name exclusion search button 422, the browser program 502 executes a search (product-name exclusion search) using the product-name exclusion search query created in step S519.

For example, assume that the user presses the product-name exclusion search button 422 when the search results for the search query "XYZ3000 scan app launch" are displayed on the product-name exclusion search guidance screen 420. In this case, the browser program 502 executes a product-name exclusion search in which the product name "XYZ3000" is excluded from the search query such as "scan app launch."

When the product-name exclusion search is executed and a page matching the search query is found, the browser program 502 displays an all-product manual search results screen 430 as illustrated in FIG. 4D on the browser 501.

FIG. 4D is an example of the all-product manual search results screen 430 displayed on the browser of the information processing apparatus 100. Note that the same elements as those in FIG. 4B are denoted by the same reference numerals.

The all-product manual search results screen 430 includes an all-product manual title 431 that clearly indicates that the search is an all-product manual search.

On the other hand, when the above-described product-name exclusion search is executed and no page matching the search query is found, the browser program 502 displays a no-search-result screen 440 as illustrated in FIG. 4E on the browser 501.

FIG. 4E is an example of the no-search-result screen 440 displayed on the browser 501 of the information processing apparatus 100. Note that the same elements as those in FIG. 4D are denoted by the same reference numerals.

The no-search-result screen 440 includes a no-search-result area 441 that informs the user that no matching pages were found in the search.

In this manner, when a search method that excludes the product name is used, the search range includes the product-common pages 203 that do not have a product name. Accordingly, when a target page that the user wants to find by a search is a product-common page, the likelihood of finding the target page is increased.

In the present embodiment, the technique has been described in which, when a search using a search query including a product name is performed on a website including product-specific pages and product-common pages, guidance is provided to the user on a search method that preferentially excludes the product name. Searching using a search query from which the product name is excluded has an effect of making it easier to find, through the search, a product-common page that does not include the product name. Accordingly, when the target page the user wants to find by a search is a product-common page, the user can perform a search using the search query from which the product name in the guidance is excluded, which increases the likelihood that the target page appears in the search results and improves user convenience.

In addition, regardless of whether a product name addition search query is included in the search results obtained by performing a search using the product name addition search query, guidance on a search method in which the product name keyword is excluded from the search query may be provided to the user.

For example, in step S515, when the browser program 502 has determined in the processing of the above-described step S514 that the product name addition search query is "included" in the search result information, i.e., in the case of step S516, in step S517, the browser program 502 displays a product-specific search result screen 450 as illustrated in FIG. 4F on the browser 501.

FIG. 4F is an example of the product-specific search result screen 450 displayed on the browser of the information processing apparatus 100. Note that the same elements as those in FIGS. 4B and 4C are denoted by the same reference numerals.

The product-specific search result screen 450 includes a search result list and an alternative search method guidance area 451.

The search result list and the alternative search method guidance area 451 include a list of search results (including the page title 412, the page URL 413, and the part 414 of body text of the page), a message 452 (including the searched model and a message indicating that the user can try an alternative method in which the model name is excluded), and a product-name exclusion search button 422.

In this manner, regardless of the search results obtained by the search method in which a model name is added, it is possible to try the search method in which a product name is excluded, further increasing the likelihood of finding the target page.

### Second Embodiment

In the first embodiment described above, the technique has been described in which, when a search using the search query including a product name is performed on the website including the product-specific pages and the product-common pages, the user is guided to the search method that preferentially excludes the product name.

In a second embodiment, a configuration is described in which a search method using a product-name exclusion search query is automatically performed, and search results obtained using the product-name exclusion search query are checked in advance to determine whether to provide a user with guidance on the search method using the product-name exclusion search query.

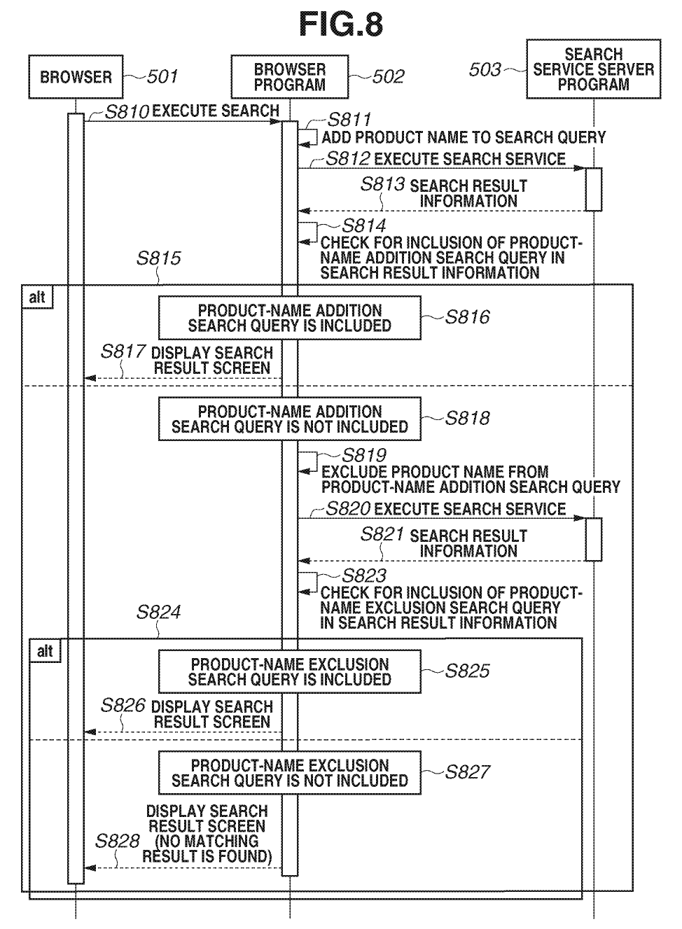

Hereinafter, the present embodiment will be described in detail with reference to FIGS. 4D, 4E, 8 , and 9.

FIG. 8 is a search processing sequence diagram illustrating a processing flow when search processing is executed on a search start screen 400 displayed on the browser 501 in the second embodiment. The browser 501, the browser program 502, and the search service server program 503, which are operation entities here, are the same as those in FIG. 5.

Processing in steps S810 to S819 is the same as the processing in steps S510 to S519 in FIG. 5, and thus description thereof will be omitted.

In step S820, the browser program 502 issues an instruction to the search service server program 503 to execute a search service using the product-name exclusion search query created in step S819.

Then, in step S821, the browser program 502 acquires the search result information returned by the search service server program 503.

Next, in step S823, the browser program 502 checks whether the search result information acquired in step S821 described above includes the keyword of the product-name exclusion search query created in step S819 described above. Processing in step S823 is the same as the processing in FIG. 6 described in the first embodiment, and thus will not be described here.

Upon completion of step S823, the processing proceeds to step S824.

In step S824, when the browser program 502 has determined in the processing of step S823 described above that the keyword of the product-name exclusion search query is "included" in the search result information, i.e., in the case of step S825, in step S826, the browser program 502 displays the all-product manual search results screen 430 as illustrated in FIG. 4D on the browser 501.

On the other hand, in step S824, when the browser program 502 has determined in the processing of step S823 that the keyword in the product-name exclusion search query is "not included" in the search result information, i.e., in the case of step S827, in step S828, the browser 501 displays the no-search-result screen 440 illustrated in FIG. 4E. The no-search-result screen 440 includes the no-search-result area 441 that informs the user that no pages were found in the search.

As described above, according to the second embodiment, when a search is performed using a search query from which the product name keyword is excluded, it is possible to determine that the search result information does not include the search query from which the product name is excluded. When the search result information does not include the search query from which the product name is excluded, there is no need to provide the user with guidance on the search method using the search query from which the product name keyword is excluded. This has an effect of eliminating the need for the user to perform an unnecessary search.

### Third Embodiment

In a third embodiment, a technique is described in which, when search result information includes a product name different from that of a product manual being viewed, guidance is provided on a search method in which the product name is excluded from a search query, and a search method in which a product name is selected and added to the search query. Hereinafter, the present embodiment will be described in detail with reference to FIGS. 4C, 9, and 10.

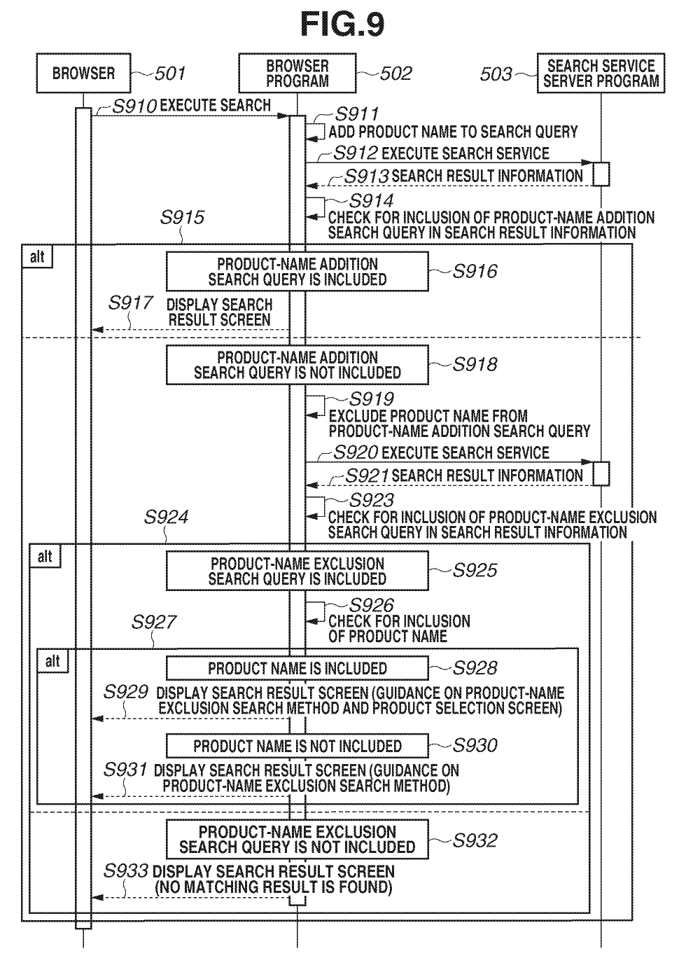

FIG. 9 is a search processing sequence diagram illustrating a processing flow when search processing is executed on a search start screen 400 displayed on the browser 501 in the third embodiment. The browser 501, the browser program 502, and the search service server program 503, which are operation entities here, are the same as those in FIG. 8.

Processing in steps S910 to S923 is the same as the processing steps S810 to S823 in FIG. 8, and thus description thereof will be omitted.

In step S924, when the browser program 502 has determined in the processing of step S923 that the keyword of the product-name exclusion search query is "included" in the search result information, i.e., in the case of step S925, the processing proceeds to step S926.

In step S926, the browser program 502 checks whether a search result item 710 includes a product name.

Processing in step S926 will be described using an example.

For example, when the character string in a title 712 of the search result items 710 is "scan application launch method | XYZ3000 | Canon," the browser program 502 extracts the character string enclosed by "|." Then, when the extracted character string is included in the product name list (i.e., product names managed by a server 110) held by the DB 117, the browser program 502 determines that "a product name is included." On the other hand, when the extracted character string is not included in the product name list held by the DB 117, the browser program 502 determines that "a product name is not included."

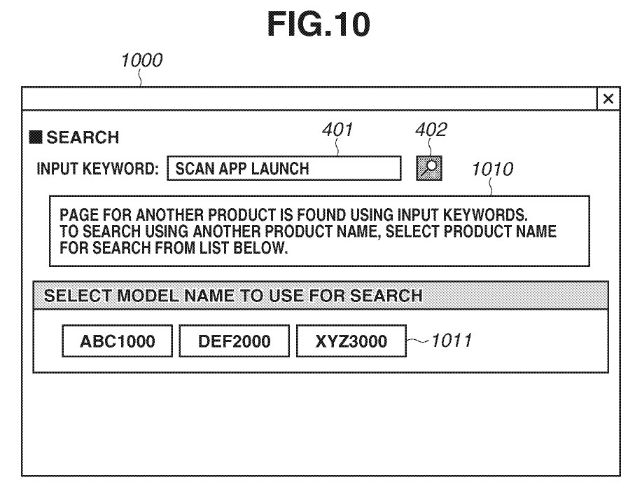

Next, in step S927, when the browser program 502 has determined in the processing of step S926 described above that "a product name is included" in the search result information, i.e., in the case of step S928, in step S929, the browser program 502 displays a product name selection search screen 1000 as illustrated in FIG. 10 on the browser 501.

FIG. 10 is a diagram illustrating an example of the product name selection search screen 1000 displayed on the browser of an information processing apparatus 100 in the third embodiment.

The product name selection search screen 1000 includes product name selection guidance text 1010 that provides the user with guidance on a search using another product name (the product name determined to be included in the search result items in step S926 described above), and a product name selection button 1011.

When the user presses the product name selection button 1011, the browser program 502 performs a search in which the product name of the selected product name selection button 1011 is added to the search query. For example, when the search query is "scan app launch" and the user presses the product name selection button 1011 for "DEF2000," the browser program 502 performs a search using the search query "DEF2000 scan app launch."

On the other hand, in step S927, when the browser program 502 has determined in the processing of step S926 that the product name is not included in the search result information, i.e., in the case of step S930, in step S931, the browser program 502 displays, on the browser 501, a product-name exclusion search guidance screen 420 illustrated in FIG. 4C. Note that the processing performed when the product-name exclusion search button 422 is pressed on the product-name exclusion search guidance screen 420 is the same as the processing described in the first embodiment, and thus description thereof will be omitted.

Processing in steps S932 to S933 is the same as the processing in steps S827 to S828 in FIG. 8 described in the second embodiment, and thus description thereof will be omitted.

As described above, according to the third embodiment, when a page including another product name is found in a search in which a product name keyword is excluded from a search query, guidance is provided to the user on a method for adding, to the search query, a keyword of the other product name found by the search and performing a search. This allows the user to become aware that a page corresponding to the search query input by the user does not exist in the product manual being viewed. Furthermore, the user can become aware that a page corresponding to the search query input by the user exists in another product manual. Therefore, when the user has mistakenly been viewing a product manual different from the target product manual and the target product name is listed as a method for searching using the other product name, an effect is achieved that the user can more easily reach a page including the search query of the target product manual.

In the above-described embodiments, the processing performed by a program (i.e., the browser program 502) that is downloaded from the contents of the server 110 to the RAM 103 of the information processing apparatus 100 and runs on the browser 501 may be performed by a program (server-side program) that runs on the server 110 in response to a request from the browser 501.

According to the embodiments, when a search is performed using the search query that includes a product name keyword, guidance is provided to the user on a search method in which the product name keyword is preferentially excluded from the search query. Accordingly, when the target page the user wants to find by a search is a product-common page that does not include a product name, the user can, as guided, perform a search using the search query that does not include a product name keyword, thereby increasing the likelihood of finding the target page.

The configuration and content of the various types of data described above are not limited thereto, and needless to say, depending on the application and purpose, the data may have various configurations and contents. Specifically, for example, in the above description, the embodiments in which a web page to be searched is a web page of a printer manual, and a product name added to a search query is the product name of the printer are described. However, the present disclosure is not limited to these embodiments. The web page to be searched may be a web page other than a manual web page. Further, the web page to be searched may be a web page related to a product other than a printer, and the product name added to a search query may be the product name of a product other than a printer. Specific examples of products other than printers include, for example, copiers, facsimile machines, scanners, smartphones, personal computers (PCs), tablet terminals, personal digital assistants (PDAs), digital cameras, music playback devices, televisions, smart speakers, robot vacuum cleaners, automatic cooking pots, refrigerators, and the like.

Although the embodiments have been described above, the present disclosure can be embodied as, for example, a system, an apparatus, a method, a program, a storage medium, or the like. Specifically, the present disclosure may be applied to a system composed of a plurality of devices, or may be applied to an apparatus composed of a single device.

Furthermore, all configurations obtained by combining the above embodiments are also included in the present disclosure.

### Other Embodiments

The present disclosure can also be realized by processing in which a program that realizes one or more functions of the above-described embodiments is supplied to a system or an apparatus via a network or a storage medium, and one or more processors of a computer of the system or the apparatus read out and execute the program. Examples of the storage medium for supplying a program code include a flexible disk, a hard disk, an optical disk, a magneto-optical disk, a Compact Disc Read-Only Memory (CD-ROM), a Compact Disc-Recordable (CD-R), a magnetic tape, a non-volatile memory card, a ROM, and a Digital Versatile Disc (DVD). It goes without saying that the present disclosure includes a case where, by executing the program code read out by the computer, the functions of the above-described embodiments are implemented, and also includes a case where, based on instructions of the program code, an operating system (OS) or the like running on the computer performs part or all of actual processing, and the functions of the above-described embodiments are implemented by that processing. It also goes without saying that the present disclosure includes a case where the program code read out from the storage medium is written into a memory provided in a function expansion board inserted into the computer or a function expansion unit connected to the computer, and then, based on instructions of the program code, a CPU or the like provided in the function expansion board or the function expansion unit performs part or all of actual processing, and the functions of the above-described embodiments are implemented by that processing. Further, supplying of the program code to the information processing apparatus can also be realized via a communication unit such as a Local Area Network (LAN) or a dedicated line, in addition to the Internet. The present disclosure can also be realized by a circuit (e.g., Application-Specific Integrated Circuit (ASIC)) that implements one or more functions.

The present disclosure may be applied either to a system including a plurality of apparatuses or to an apparatus including a single apparatus.

The present disclosure is not limited to the above-described embodiments, and various modifications (including organic combinations of the embodiments) are possible based on the spirit of the present disclosure, and such modifications are not intended to be excluded from the scope of the present disclosure. That is, all configurations obtained by combining the above-described embodiments and their modifications are included in the present disclosure.

According to the present disclosure, even when a target page that the user wants to find by a search is a product-common page that does not include a product name, the likelihood of finding the target page can be increased.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)^{TM}), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-048791, filed March 24, 2025, which is hereby incorporated by reference herein in its entirety.

What is claimed is:

1. A non-transitory computer-readable storage medium storing a program for displaying, on a web browser, a search result of content in a website obtained from a search service server in response to a search instruction for the website including a product-specific page and a product-common page,
wherein the program causes a computer to function as:
a first creation unit configured to create a first search query by automatically adding, by the program, a product name corresponding to the product-specific page to a search query input from the product-specific page being viewed in the web browser;
a first acquisition unit configured to communicate with the search service server and acquire a first search result obtained by searching the website using the first search query;
a first determination unit configured to determine whether a character string of the first search query is included in the acquired first search result; and
a first execution unit configured to, in a case where the character string of the first search query is not included in the first search result, execute processing for performing a search using a search query obtained by excluding the product name automatically added by the program in creating the first search query from the first search query.

2. The non-transitory computer-readable storage medium according to claim 1,
wherein the program causes the computer to further function as a second creation unit configured to, in the case where the character string of the first search query is not included in the first search result, create a second search query obtained by excluding the product name from the first search query, and
wherein the first execution unit displays a screen including a button for receiving, from a user, instructions to execute a search using the second search query.

3. The non-transitory computer-readable storage medium according to claim 1, wherein the first execution unit provides guidance on a method for performing a search using the search query obtained by excluding the product name from the first search query regardless of whether the character string of the first search query is included in the first search result.

4. The non-transitory computer-readable storage medium according to claim 1, wherein the program is downloaded from the website to the web browser and operates in the web browser.

5. A non-transitory computer-readable storage medium storing a program for displaying, on a web browser, a search result of content in a website obtained from a search service server in response to a search instruction for the website including a product-specific page and a product-common page,
wherein the program causes a computer to function as:
a first creation unit configured to create a first search query by adding a product name corresponding to the product-specific page to a search query input from the product-specific page being viewed in the web browser;
a first acquisition unit configured to communicate with the search service server and acquire a first search result obtained by searching the website using the first search query;
a first determination unit configured to determine whether a character string of the first search query is included in the acquired first search result;
a first display control unit configured to, in a case where the character string of the first search query is included in the first search result, display a search result based on the first search result;
a second creation unit configured to, in a case where the character string of the first search query is not included in the first search result, create a second search query obtained by excluding the product name from the first search query;
a second acquisition unit configured to communicate with the search service server and acquire a second search result obtained by searching the website using the second search query; and
a second display control unit configured to, in the case where the character string of the first search query is not included in the first search result, display a search result based on the second search result.

6. The non-transitory computer-readable storage medium according to claim 5, wherein the program causes the computer to further function as:
a second determination unit configured to determine whether a character string of the second search query is included in the acquired second search result;
a third determination unit configured to, in a case where the character string of the second search query is included in the second search result, determine whether a product name included in the second search result is included in a product name list managed by a server that provides the website; and
a second execution unit configured to, in a case where the product name included in the second search result is included in the product name list, execute processing for performing a search using a search query obtained by including the product name included in the second search result that is included in the product name list.

7. The non-transitory computer-readable storage medium according to claim 6, wherein the second execution unit displays a screen including a button for receiving, from a user, instructions to execute a search using a search query obtained by adding the product name included in the second search result that is included in the product name list to the second search query.

8. The non-transitory computer-readable storage medium according to claim 6, wherein the second execution unit displays, for each product name included in the second search result that is included in the product name list, a button for receiving, from the user, instructions to execute a search using a search query obtained by adding the product name to the second search query.

9. The non-transitory computer-readable storage medium according to claim 8, wherein the program causes the computer to further function as:
a third creation unit configured to, in a case where any button displayed by the second execution unit is selected, create a third search query obtained by adding a product name corresponding to the button to the second search query;
a third acquisition unit configured to communicate with the search service server and acquire a third search result obtained by searching the website using the third search query; and
a third display control unit configured to display a search result based on the third search result.

10. An information processing apparatus capable of operating the program according to claim 1 in a web browser.

11. A control method for an information processing apparatus configured to display, on a web browser, a search result of content in a website obtained from a search service server in response to a search instruction for the website including a product-specific page and a product-common page, the control method comprising:
creating a first search query by automatically adding a product name corresponding to the product-specific page to a search query input from the product-specific page being viewed in the web browser;
communicating with the search service server and acquiring a first search result obtained by searching the website using the first search query;
determining whether a character string of the first search query is included in the acquired first search result; and
executing, in a case where the character string of the first search query is not included in the first search result, processing for performing a search using a search query obtained by excluding the product name automatically added by the program in creating the first search query from the first search query.

12. A control method for an information processing apparatus configured to display, on a web browser, a search result of content in a website obtained from a search service server in response to a search instruction for the website including a product-specific page and a product-common page, the control method comprising:
creating a first search query by automatically adding a product name corresponding to the product-specific page to a search query input from the product-specific page being viewed in the web browser;
communicating with the search service server and acquiring a first search result obtained by searching the website using the first search query;
determining whether a character string of the first search query is included in the acquired first search result;
displaying, in a case where the character string of the first search query is included in the first search result, a search result based on the first search result;
creating, in a case where the character string of the first search query is not included in the first search result, a second search query obtained by excluding, from the first search query, the product name automatically added in creating the first search query;
communicating with the search service server and acquiring a second search result obtained by searching the website using the second search query; and
displaying, in the case where the character string of the first search query is not included in the first search result, a search result based on the second search result.

13. The control method for an information processing apparatus according to claim 12, the control method further comprising:
determining whether a character string of the second search query is included in the acquired second search result;
determining, in a case where the character string of the second search query is included in the second search result, whether a product name included in the second search result is included in a product name list managed by a server that provides the website; and
executing, in a case where the product name included in the second search result is included in the product name list, processing for performing a search using a search query obtained by including the product name included in the second search result that is included in the product name list.
